(19) United States
(12) Patent Application Publication
(10) Pub. No.: US 2015/0286382 A1
(43) Pub. Date: Oct. 8, 2015

(54) METHOD FOR CREATING GRAPHICAL WINDOW BLINDS

(71) Applicants: James Pruey, Williamsport, PA (US); Catherine Pruey, Williamsport, PA (US)

(72) Inventors: James Pruey, Williamsport, PA (US); Catherine Pruey, Williamsport, PA (US)

(21) Appl. No.: 14/244,102

(22) Filed: Apr. 3, 2014

(51) Int. Cl. G06F 3/0484

(52) U.S. Cl. CPC G06F 3/04847; G06F 3/04842

(57) ABSTRACT

A method of creating a graphical display comprising the steps of: arranging graphical design over a plurality of vertical blinds; transferring a portion of the graphical design onto each vertical bland; and enabling the display of the graphical design upon the closing of the plurality of vertical blinds. In one particular embodiment, the plurality of vertical blinds may be placed in a window. The graphical design may include at least one character, where the at least one character is associated with a festive holiday.

### BACKGROUND OF THE INVENTION

1. Field of Invention

The present invention leads to a method of creating graphical window blinds.

2. Description of Related Art

Window blinds provide a means to shade incoming light and privacy for the interior of a residence or office window. Normally window blinds have a solid color and most of window blinds are white. Since the window blinds are visible from the exterior of the window it would be advantageous to have a method to create an graphical design on the window blinds to provide an attractive display within the window.

### SUMMARY OF THE INVENTION

The present invention relates to a method of creating a graphical display comprising the steps of: arranging graphical design over a plurality of vertical blinds; transferring a portion of the graphical design onto each vertical bland; and enabling the display of the graphical design upon the closing of the plurality of vertical blinds. In one particular embodiment, the plurality of vertical blinds may be placed in a window. The graphical design may include at least one character, where the at least one character is associated with a festive holiday.

### BRIEF DESCRIPTION OF DRAWINGS

FIG. 1A depicts a graphical display within a window in accordance with the present invention.

FIG. 1B depicts blinds that create the window display shown in FIG. 1A.

FIG. 1C depicts an alternative graphical window display in accordance with the present invention.

### DETAILED DESCRIPTION

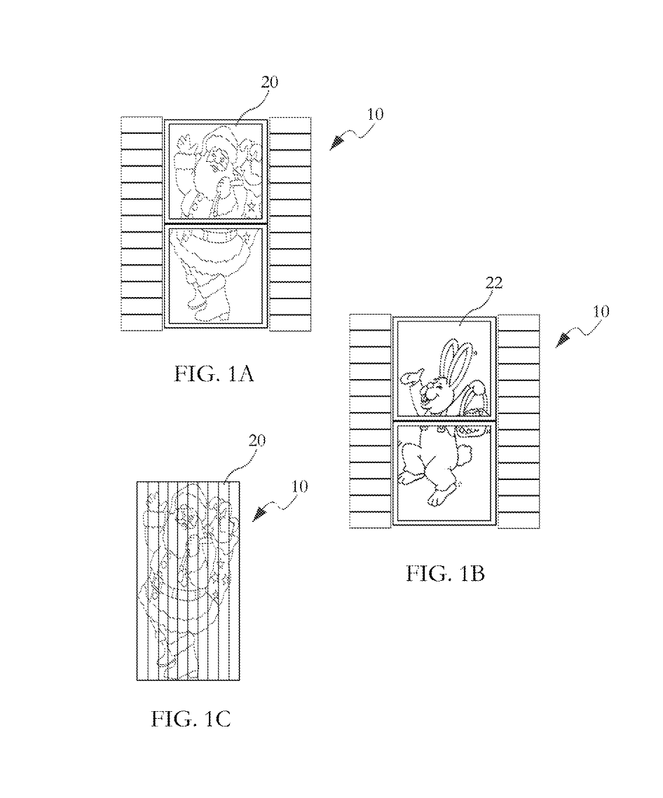

The present invention relates to a method of creating a graphical display through the use of conventional vertical blinds. As is known a series of vertical blinds are used to shade or prohibit an outside view into a window. The present invention places a graphical design that comes together once the blinds are in a closed position. The design is evenly distributed across the series of blinds so that once the user places the blinds in a closed position the display is shown as one composite figure or a composition. FIG. 1A depicts graphical design 20 in accordance with the present invention. The graphical design 20 is shown through a window 10. The graphical design 20 is created through the use of a series of vertical blinds that is shown in FIG. 1B. The graphical representation shown in FIG. 1B is created over a plurality of vertical blinds. Once the blinds are placed in a closed position the graphical display is shown through the window 10.

FIG. 1C depicts an alternative graphical design 22. The graphical design 22 is shown through the window tint. These graphical displays may be associated with various characters or other graphical scenes associated with particular holidays as shown in FIGS. 1A and 1C. Consequently the graphical vertical blinds display a desired graphical representation as printed on the outside face of the window blinds. The blinds function in the manner known and associated with a typical vertical blind. The method of creating displays involves the painting of the graphical display on the outside surface of the blinds. This method includes first sizing the graphical display to fit a particular series of vertical blinds and then painting the graphical display over the series of blinds on the outside surface thereof. Once the display is placed on each blind the blinds may be placed in a closed position to create the graphical display shown on the outside surface. The instant invention has been shown and described in what it considers to be the most practical and preferred embodiments. It is recognized, however, that departures may be made there from within the scope of the invention and that obvious modifications will occur to a person skilled in the art.

What is claimed is:

1. A method of creating a graphical display comprising the steps of:
a. arranging graphical design over a plurality of vertical blinds;
b. transferring a portion of the graphical design onto each vertical bland; and
c. enabling the display of the graphical design upon the closing of the plurality of vertical blinds.

2. The method of creating a graphical display according to claim 1 where the plurality of vertical blinds are placed in a window.

3. The method of creating a graphical display according to claim 1, where the graphical design includes at least one character.

4. The method of creating a graphical display according to claim 4, where the at least one character is associated with a festive holiday.
